(19) United States
(12) Patent Application Publication
(10) Pub. No.: US 2012/0173516 A1
(43) Pub. Date: Jul. 5, 2012

(54) WORK FILE RECYCLING

(75) Inventors: Florian Michael Waas, San Mateo, CA (US); Joy Jie Kent, Belmont, CA (US)

(73) Assignee: EMC CORPORATION, Hopkinton, MA (US)

(21) Appl. No.: 12/983,196

(22) Filed: Dec. 31, 2010

(51) Int. Cl. G06F 17/30

(52) U.S. Cl. 707/718; 707/E17.017

(57) ABSTRACT

A method, article of manufacture, and apparatus for processing information are disclosed. In some embodiments, this includes receiving a query plan, generating a work file based on the query plan, associating the query plan with a work file, storing the association, and storing the work file in a storage device after the query plan has executed. In some embodiments, a hash of the query plan may be generated.

### CROSS-REFERENCE TO RELATED APPLICATIONS

This application is related to co-pending U.S. patent application Ser. No. ______ (Attorney Docket No. EMC-10-427) for AUGMENTED QUERY PROCESSING and filed concurrently herewith, which is incorporated herein by reference for all purposes.

### FIELD OF THE INVENTION

The present invention relates generally to information storage systems, and more particularly, to systems and methods of processing information.

### BACKGROUND OF THE INVENTION

A modern database may contain large amounts of data, and typically, a user does not need know all of the information contained in the database. In fact, most of the data in the database may be irrelevant to the user. In order to find relevant information, a user may query, or search, a database.

Searching databases, especially large databases, may be resource intensive, time consuming, or both. This problem is exacerbated if a database is asked to process identical queries from multiple users or clients.

There is a need, therefore, for an improved method, article of manufacture, and apparatus for processing information.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram of sample query plan.

FIG. 2 illustrates a method to process information in accordance with some embodiments.

FIG. 3 illustrates a method to process information in accordance with some embodiments.

### DETAILED DESCRIPTION

A detailed description of one or more embodiments of the invention is provided below along with accompanying figures that illustrate the principles of the invention. While the invention is described in conjunction with such embodiment(s), it should be understood that the invention is not limited to any one embodiment. On the contrary, the scope of the invention is limited only by the claims and the invention encompasses numerous alternatives, modifications, and equivalents. For the purpose of example, numerous specific details are set forth in the following description in order to provide a thorough understanding of the present invention. These details are provided for the purpose of example, and the present invention may be practiced according to the claims without some or all of these specific details. For the purpose of clarity, technical material that is known in the technical fields related to the invention has not been described in detail so that the present invention is not unnecessarily obscured.

It should be appreciated that the present invention can be implemented in numerous ways, including as a process, an apparatus, a system, a device, a method, or a computer readable medium such as a computer readable storage medium containing computer readable instructions or computer program code, or as a computer program product, comprising a computer usable medium having a computer readable program code embodied therein. In the context of this disclosure, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical means system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer readable instructions may be referred to as components or modules. Applications may be hardwired or hard coded in hardware or take the form of software executing on a general purpose computer or be hardwired or hard coded in hardware such that when the software is loaded into and/or executed by the computer, the computer becomes an apparatus for practicing the invention. Applications may also be downloaded in whole or in part through the use of a software development kit or toolkit that enables the creation and implementation of the present invention. In this specification, these implementations, or any other form that the invention may take, may be referred to as techniques. In general, the order of the steps of disclosed processes may be altered within the scope of the invention.

An embodiment of the invention will be described with reference to a data storage system in the form of a storage system configured to store files, but it should be understood that the principles of the invention are not limited to data storage systems. Rather, they are applicable to any system capable of storing and handling various types of objects, in analog, digital, or other form. Although terms such as document, file, object, etc. may be used by way of example, the principles of the invention are not limited to any particular form of representing and storing data or other information; rather, they are equally applicable to any object capable of representing information.

Disclosed herein are a method and system to efficiently process information. Conventional database systems, or databases, typically transform a query into a series of operators. Typically, a query processor is a component in the database system that processes queries. These operators may include filter, hash join, aggregate, materialize, and sort among others. When performing these operations, conventional databases typically use up of memory and need to create temporary work files, or spillover files. The conventional database may run out of memory due to physical restraints (e.g. there physically is no more memory to process the query), or administrative restraints (e.g. an administrator has allocated a certain amount of memory for the query).

For example, suppose a travel agency website has a database of flights. The database may have one million rows of flight information. When a user searches for a desired flight, the one million rows of flights are filtered according to the criteria set by the user (e.g. starting point, destination, number of transfers, date, time, etc.). Depending on the results of the filter, in some embodiments, a substantial number of rows may still remain, and the database's memory may not be sufficient to handle the query without spilling over the filter results into storage (e.g. creating a temporary work file). The filtered results may then be sorted to another criteria set by the user (e.g. price, number of transfers, etc.) Again, the sort operation may have a substantial number of rows, and memory may not be sufficient to handle the query. Further, depending on the size of the database and the operation performed, the temporary work files may be large and require substantial resources to create. After the query has been processed and the desired flight is located, the temporary work files are deleted. If another user searched for the same desired flight, the whole process of creating the same temporary work files would be repeated.

Further, in some embodiments, every operator may produce a work file, or materialize its intermediate result, regardless of the amount of memory. For example, a filter operator may create a work file with the filtered data, even if the filtered data only takes up 1 MB. The sort operator may also create its own work file with the sorted data. In some embodiments, work files are only created as a part of an execution of an operator. For example, unlike FILTER, SORT needs to inspect all rows before producing the first row (the last input row could be the one that sorts to the top). As part of the inspection, SORT has to write out data and re-read it, potentially several times. The enhances techniques described herein are applicable to situations in which work files are generated as part of an execution, or work files are generated after each operator and materialized.

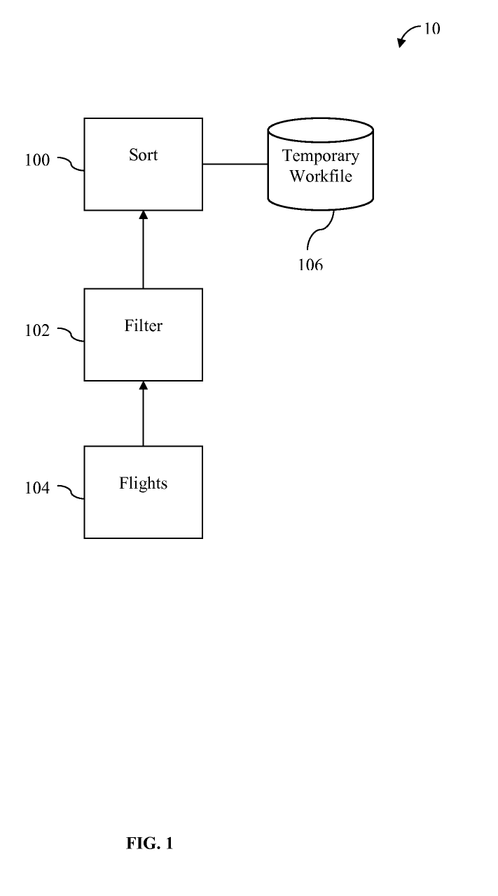

FIG. 1 illustrates a sample query plan. Query Plan 10 contains a Flights database 104, a Filter operator 102, a Sort operator 100, and a Temporary Work File 106. Flights database 104 contains one million rows of flight information. Filter operator 102 filters the rows of Flights database 104 according to a criterion set by a user, and Sort operator 100 sorts the rows of the filtered rows according to a criteria set by a user. Temporary Work File 106 is used to materialize the results to a user.

In some embodiments, the temporary work files are saved for use in future queries, along with a fingerprint associated with the temporary work files. Using the example above, suppose the user was interested in all flights arriving in LAX, and that there were 30,000 flights that were arriving in LAX. The resulting temporary work file for the filter operation DESTINATION=“LAX” would be the unsorted 30,000 flights. In some embodiments, the fingerprint that describes the resulting temporary work file may be FILTER “LAX”=DESTINATION, and associated with the resulting temporary work file.

In some embodiments, a temporary work file may be associated with a fingerprint in an index, or a table. The index, or table, may be stored in memory or may be stored in a non-volatile storage device.

The filtered results may then be sorted according to price. The next resulting temporary work file for the sort operation would be the sorted 30,000 flights. In some embodiments, the fingerprint that describes the next resulting temporary work file may be SORT BY PRICE (FILTER “LAX”=DESTINATION), and associated with the resulting temporary work file.

With the temporary work files and their respective fingerprints saved, subsequent queries can be processed in a more efficient manner. For example, suppose a subsequent user also wanted to search for all flights arriving in LAX and wanted to sort by price. Using conventional techniques, the query would be processed with no regard to previous queries—all one million flights would be located, 30,000 flights would be filtered from the million flights, and the 30,000 filtered flights would be sorted. However, using the enhanced techniques described herein, the two operations can be skipped. When the database receives the subsequent user's query, a fingerprint will be generated based on the subsequent query. In this case, it would compute the possible fingerprints of filtering for LAX, and sorting by price. The fingerprints would then be compared to the saved fingerprints by looking up an index to find any matches. Since a previous user had an identical query, a fingerprint match would be found for both operations. The temporary work file associated with the matched fingerprint would be re-used to present the query results to the subsequent user. Thus, the subsequent query did not have to locate one million flights, filter 30,000 flights from the one million flights, and sort the 30,000 filtered flights. Rather, the subsequent query re-used the previous query's temporary work file to present the query results to the subsequent user, resulting in substantial performance benefits.

In some embodiments, it may be preferable to hash the query plan. The hash may be generated through a variety of methods, and may be compared to a hash of a previous query. Identical queries can reuse work files, and an efficient way to determine if two queries are identical is by comparing the hashes of each query. In some embodiments, a query plan may be reduced to a string of text, and the resulting string of text may be hashed. The resulting hash may be used as the fingerprint for the query. This allows for a quick comparison since hashes are relatively small in size. Thus, the hash may be stored in a table (or hash table) and associated with the query's temporary work files. The table and the associated temporary work files may be stored in a non-volatile storage device, or the table may be stored in memory while the temporary work files are stored in a non-volatile device. The following is a sample hash table:

| Hash | Temporary Work File |
|---|---|
| 3F2A | Work File 1 |
| 9876 | Work File 2 |

When a subsequent query is received, its hash may be computed. If the subsequent query's hash matches a hash found in the hash table, it may be preferable, or even mandatory in some cases, to employ additional steps to verify that the two queries are actually identical (this may be due to hash collisions). In some embodiments, this may involve walking through the two query plans to make sure they are identical. If the two query plans are identical, then the work files may be reused. Using hashes, identical matches can be identified in an efficient manner. Instead of walking through two query plans every time, which may be a resource intensive task, the plans are only walked through if their hashes match.

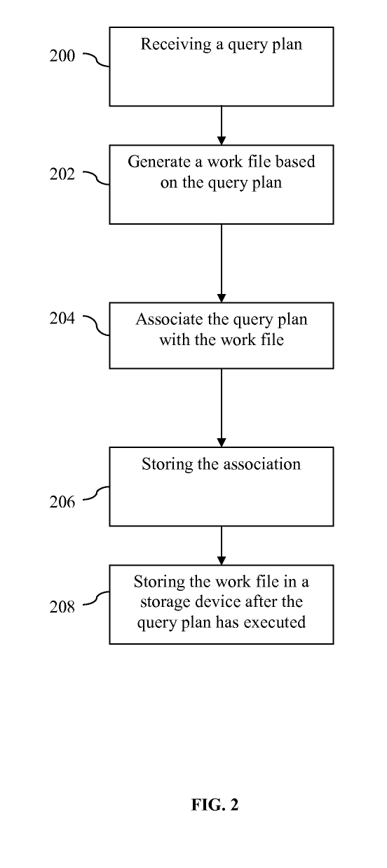

FIG. 2 illustrates a method to process information in accordance with some embodiments. In step 200, a query plan is received. In step 202, a work file based on the query plan is generated. In step 204, the query plan is associated with the work file. In step 206, the association is stored. In step 208, the work file is stored in a storage device after the query plan has executed. The storage device may be the same storage device in which the work file was created (e.g. the work file is not deleted after the query plan has executed).

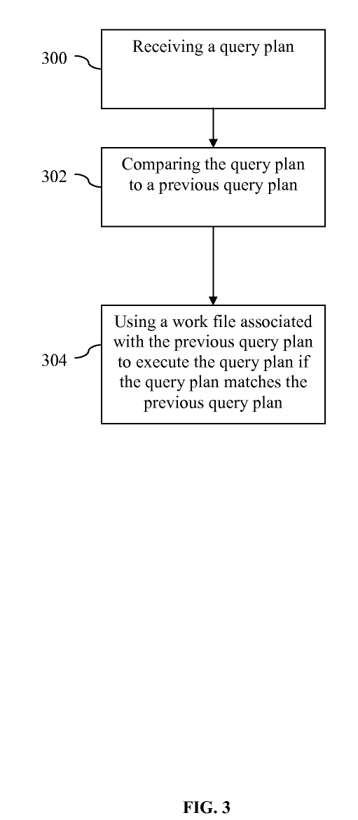

FIG. 3 illustrates a method to process information in accordance with some embodiments. In step 300, a query plan is received. In step 302, the query plan is compared to a previous query plan. In step 304, a work file associated with the previous query plan is used to execute It should be noted that if a subsequent query does not match any fingerprint in the index, there is no substantial performance difference as compared to conventional databases. Comparing fingerprints (e.g. hashes, etc.) requires little system resources compared to processing a query plan and generating temporary work files. Thus, in a best case scenario, the enhanced techniques described herein may be used to skip all operators during a query execution, and in the worse case scenario, all the operators are processed as a conventional database would do.

In some embodiments, it may be preferable to delete some of the temporary work files. For example, work files that are out of date due to a change in the database may be deleted. In addition, work files may require considerable storage space, and it may not be feasible to keep every work file indefinitely. Standard cache eviction policies, such as Least Recently Used (LRU), may be used to determine which work files to delete, and when to delete them. Further, it may be preferable to delete the temporary work files and the index upon reboot of the database.

Creation of work files may also be influenced by things external to the query executor. For example, policies may dictate that work file generation should be skipped for queries that are unlikely to generate re-usable intermediate results. Cost estimates may also be used to influence cache eviction policy and work file generation.

In some embodiments, deleting temporary work files may be based on policy. For example, a policy may dictate that all work files over 1 GB be deleted if the work file has not been utilized ten times in the previous day. In another example, suppose Work File A is 100 kb and is re-used 100 times, while Work File B is 3 MB and is reused 10 times. Since Work File B may take a considerably larger amount of resources to create than Work File A, it may be preferable to retain Work File B even if its utilization rate is less than Work File A.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor.

All references cited herein are intended to be incorporated by reference. Although the present invention has been described above in terms of specific embodiments, it is anticipated that alterations and modifications to this invention will no doubt become apparent to those skilled in the art and may be practiced within the scope and equivalents of the appended claims. More than one computer may be used, such as by using multiple computers in a parallel or load-sharing arrangement or distributing tasks across multiple computers such that, as a whole, they perform the functions of the components identified herein; i.e. they take the place of a single computer. Various functions described above may be performed by a single process or groups of processes, on a single computer or distributed over several computers. Processes may invoke other processes to handle certain tasks. A single storage device may be used, or several may be used to take the place of a single storage device. The present embodiments are to be considered as illustrative and not restrictive, and the invention is not to be limited to the details given herein. It is therefore intended that the disclosure and following claims be interpreted as covering all such alterations and modifications as fall within the true spirit and scope of the invention.

What is claimed is:

1. A method for processing information, comprising:
receiving a query plan;
generating a work file based on the query plan;
generating a hash of the query plan;
associating the query plan with the work file, wherein associating the query plan with the work file includes associating the hash of the query plan with the work file;
storing the association; and
storing the work file in a storage device after the query plan has executed.

2. (canceled)

3. (canceled)

4. The method as recited in claim 1, wherein the storage device is memory.

5. The method as recited in claim 1, wherein the storage device is a non-volatile storage device.

6. The method as recited in claim 1, wherein generating the work file based on the query plan includes generating a first work file for a first portion of the query plan.

7. A system for processing information, comprising a storage device and a processor configured to:
receive a query plan;
generate a work file based on the query plan;
generate a hash of the query plan;
associate the query plan with a work file, wherein associate the query plan with the work file includes associating the hash of the query plan with the work file;
store the association; and
store the work file in a storage device after the query plan has executed.

8. (canceled)

9. (canceled)

10. The system as recited in claim 8, wherein the storage device is memory.

11. The system as recited in claim 8, wherein the storage device is a non-volatile storage device.

12. The system as recited in claim 8, wherein generate the work file based on the query plan includes generate a first work file for a first portion of the query plan.

13. A computer program product for processing information data, comprising a computer readable medium having program instructions embodied therein for:
receiving a query plan;
generating a work file based on the query plan;
generating a hash of the query plan;
associating the query plan with a work file, wherein associating the query plan with the work file includes associating the hash of the query plan with the work file;
storing the association; and
storing the work file in a storage device after the query plan has executed.

14. (canceled)

15. (canceled)

16. The computer program product as recited in claim 13, wherein the storage device is memory.

17. The computer program product as recited in claim 13, wherein the storage device is a non-volatile storage device.

18. The computer program product as recited in claim 13, wherein generating the work file based on the query plan includes generating a first work file for a first portion of the query plan.
